(19) United States
(12) Patent Application Publication
(10) Pub. No.: US 2009/0044177 A1
(43) Pub. Date: Feb. 12, 2009

(54) METHOD AND APPARATUS FOR PROFILE ENHANCED SOURCE CODE ANALYZER RESULTS

(76) Inventors: Cary Lee Bates, Rochester, MN (US); Victor John Gettler, Lexington, KY (US)

Correspondence Address: DUKE W. YEE, YEE AND ASSOCIATES, P.C., P.O. BOX 802333, DALLAS, TX, 75380, US

(21) Appl. No.: 11/836,573

(22) Filed: Aug. 9, 2007

(51) Int. Cl. G06F 9/44

(52) U.S. Cl. 717/131

(57) ABSTRACT

A computer implemented method, apparatus, and computer program product for generating enhanced source code analyzer results. The process receives a plurality of results generated by a static code analysis for a computer program. Profile data associated with the computer program is received. A priority for each result in the plurality of results is identified to form prioritized results. A prioritized static analysis report is generated using the prioritized results. The prioritized static analysis report indicates the priority for each result in the plurality of results.

### BACKGROUND OF THE INVENTION

1. Field of the Invention

The present invention is related generally to a data processing system and in particular to a method and apparatus for static source code analysis. More particularly, the present invention is directed to a computer implemented method, apparatus, and computer usable program code for indicating the execution frequency of code paths that include errors in source code analyzer results.

2. Description of the Related Art

Static code analysis is the analysis of computer program code that is performed statically, without executing the computer program code. In other words, static code analysis is performed prior to executing the code, such as, during compile time. Static code analysis may be performed on the computer program source code and/or on object code. Static code analysis is performed by software that analyzes the source code and generates a report or results list providing information describing potential errors and problems in the source code. Typically, a human user manually reviews this report to identify significant problems in the source code that may need to be corrected.

Today, one of the problems computer programmers frequently encounter while examining the results of static source code analysis is that most of the identified problems seem worthless because the identified problems occur in code that may never be run or is only run in exceptional situations. After examining static analysis reports where the majority of the identified errors tend to be of this nature, the computer programmer can become fatigued and less motivated to continue examining the static analysis results. This problem can lead to a significant problem in the code being missed or ignored by the programmer because information identifying the problem is buried in a multitude of useless or unimportant information.

### SUMMARY OF THE INVENTION

The illustrative embodiments provide a computer implemented method, apparatus, and computer usable program code for generating enhanced source code analyzer results. In one embodiment, the process receives a plurality of results generated by a static code analysis for a computer program. Profile data associated with the computer program is received. A priority for each result in the plurality of results is identified to form prioritized results. A prioritized static analysis report is generated using the prioritized results. The prioritized static analysis report indicates the priority for each result in the plurality of results.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a static analyzer for generating prioritized static analysis results in accordance with an illustrative embodiment;

FIG. 4 is a flowchart illustrating a process for generating prioritized static analysis results in accordance with an illustrative embodiment;

FIG. 5 is an exemplary illustration of program source code in accordance with an illustrative embodiment;

FIG. 6 is an exemplary illustration of code coverage data in accordance with an illustrative embodiment; and

FIGS. 7A and 7B is an exemplary illustration of a prioritized static analysis report in accordance with an illustrative embodiment.

### DETAILED DESCRIPTION OF THE PREFERRED EMBODIMENT

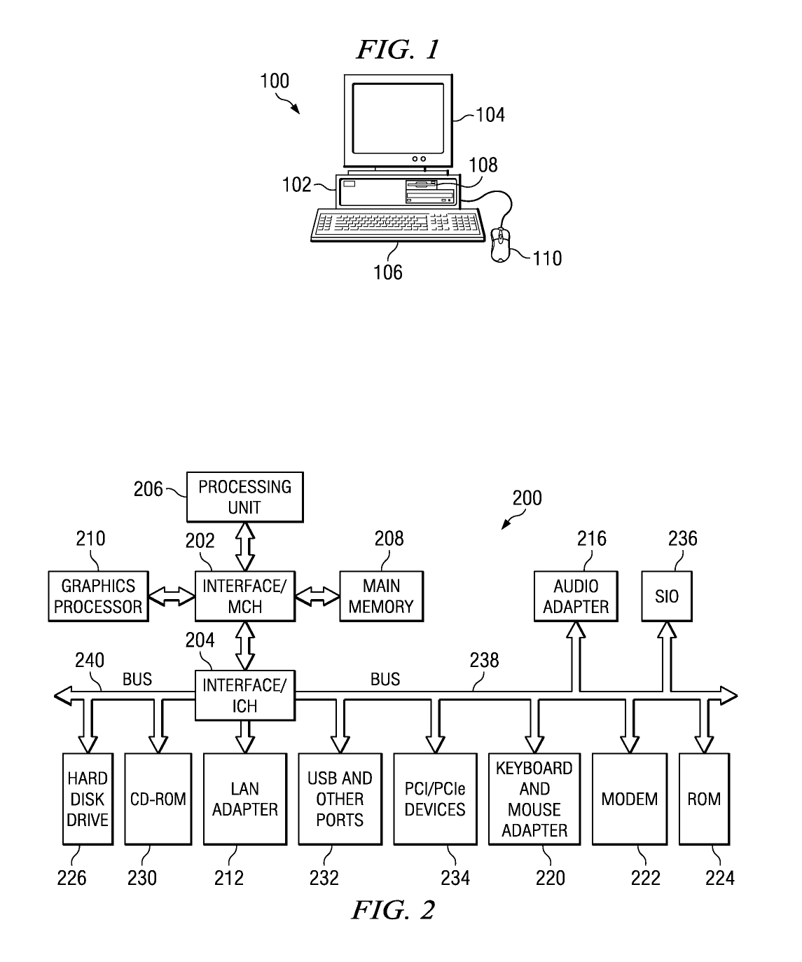

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices could include, for example, a joystick, a touchpad, a touch screen, a trackball, and a microphone.

Computer 100 also includes a processor for executing computer program code. Computer 100 implements a software static analyzer for performing static analysis of computer program source code in accordance with the illustrative embodiments.

Computer 100 may be implemented in any suitable computing device, including, without limitation, an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

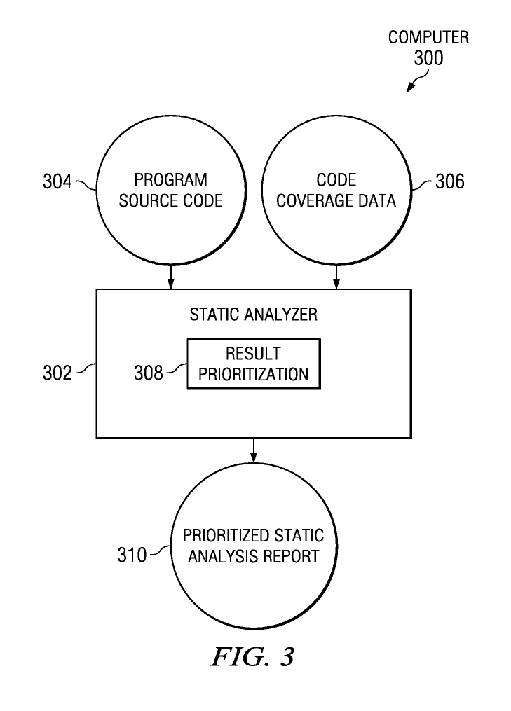

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including an interface and memory controller hub (interface/MCH) 202 and an interface and input/output (I/O) controller hub (interface/ICH) 204. Processing unit 206, main memory 208, and graphics processor 210 are coupled to interface and memory controller hub 202. Processing unit 206 may contain one or more processors and even may be implemented using one or more heterogeneous processor systems. Graphics processor 210 may be coupled to interface and memory controller hub 202 through an accelerated graphics port (AGP), for example.

In the depicted example, local area network (LAN) adapter 212 is coupled to interface and I/O controller hub 204, audio adapter 216, keyboard and mouse adapter 220, modem 222, read only memory (ROM) 224, universal serial bus (USB) and other ports 232. PCI/PCIe devices 234 are coupled to interface and I/O controller hub 204 through bus 238. Hard disk drive (HDD) 226 and CD-ROM 230 are coupled to interface and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to interface and I/O controller hub 204.

An operating system runs on processing unit 206. This operating system coordinates and controls various components within data processing system 200 in FIG. 2. The operating system may be a commercially available operating system, such as Microsoft® Windows Vista™. (Microsoft® and Windows Vista are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226. These instructions may be loaded into main memory 208 for execution by processing unit 206. The processes of the illustrative embodiments may be performed by processing unit 206 using computer implemented instructions, which may be located in a memory. An example of a memory is main memory 208, read only memory 224, or one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in interface and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

The output of static code analysis tools have been used for many years to find potential program errors before they are discovered by the user during utilization of a program after sale of the product. Many times the problems found by static source code analyzers cannot be caught by test cases. For example, if a variable fails to initialize and it happens that there is always a zero in the variable's storage, then the un-initialized variable may not cause a problem. However, if the calling module or the containing module is changed, or a new level of optimization changes the order of variables in storage, the un-initialized variable may overlay a different section of memory and may now contain random non-zero data which will cause the program to begin failing for no apparent reason. Therefore, static source code analyzers are often used for the early identification of these types of problems.

A major drawback of currently available static code analyzers is that the volume of information produced by a static code analyzer can be overwhelming. A lot of errors occur in frequently run paths, but more errors exist in infrequently executed paths which have not been tested. A static source code analyzer can be used to obtain information regarding these errors. However, the currently available static source code analyzers report all occurrences of problems equally without distinguishing between problems in frequently executed paths, problems in infrequently executed paths, and paths not executed at all. The illustrative embodiments recognize that the results indicating problems on frequently executed paths, which are more important to identify and correct, can be lost in the sea of messages regarding problems in the unexecuted paths.

After examining static analysis reports where the majority of the identified errors tend to be errors that are unimportant or irrelevant, the computer programmer can become fatigued and less motivated to continue examining the static analysis results. The illustrative embodiments recognize that this problem can lead to the programmer missing information that may lead to a significant problem in the code because information identifying the important problem is buried in a multitude of useless or unimportant information.

In addition, the process of fixing and releasing a product containing a significant problem in the program code can be expensive for both the seller and the purchaser of the product. Moreover, when a problem is encountered with the code after the product has been released, a seller must typically factor in the likelihood that the code problem will be encountered by other customers using the program to determine whether or not to produce and release a fix or patch to correct or compensate for the code problem. However, reports produced by currently available static source code analyzers do not provide any information as to how often particular code paths are executed. This deficiency makes it difficult for a manufacturer, programmer, seller, or user to accurately determine the odds that a problem in a particular part of the code will be encountered in the customer's environment.

The illustrative embodiments provide a computer implemented method, apparatus, and computer usable program code for generating enhanced source code analyzer results. In one embodiment, the process receives a plurality of results generated by a static code analysis for a computer program. Profile data associated with the computer program is received. A priority for each result in the plurality of results is identified to form prioritized results. A prioritized static analysis report is generated using the prioritized results. The prioritized static analysis report indicates the priority for each result in the plurality of results.

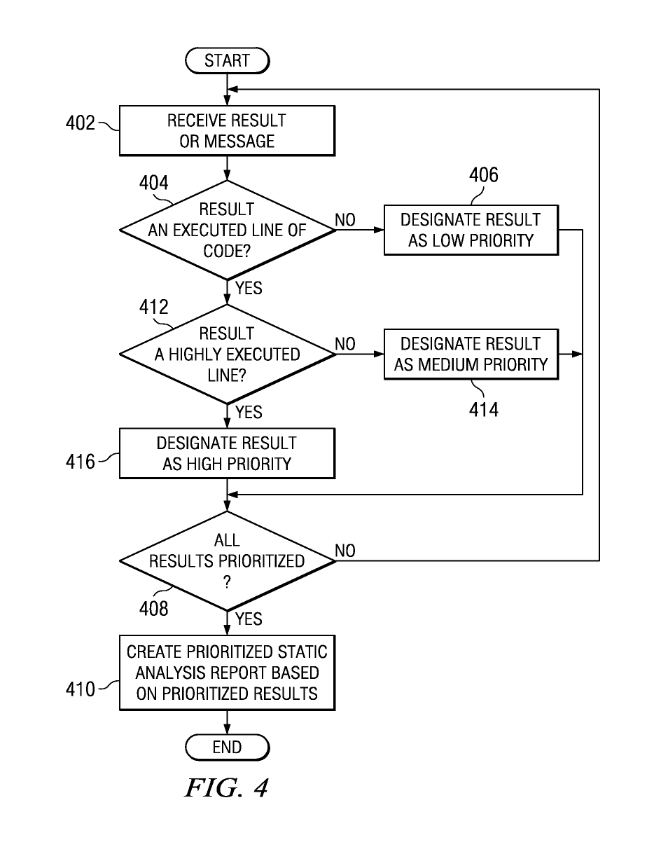

FIG. 3 is a block diagram of a static analyzer for generating prioritized static analysis results in accordance with an illustrative embodiment. Computer 300 may be implemented using any type of computing device, such as a personal computer, laptop, personal digital assistant, or any other computing device depicted in FIGS. 1 and 2.

Static analyzer 302 is a software static source code analyzer for performing static analysis of program source code and/or object code. Static analyzer 302 may be implemented in any type of known or available static source code analyzer, such as, without limitation, FindBugs™, Sparse, a lint static code analyzer, or IBM® BEAM static source analyzer.

Program source code 304 is a computer program source code. Program source code 304 may be written in any known or available programming language, including, but not limited to, C programming language, C++ programming language, Java programming language, or any other programming language.

Code coverage data 306 is data generated by a software code coverage component for testing program source code 304. Code coverage data 306 includes, but is not limited to, statement coverage data, condition coverage data, path coverage data, and/or entry and exit coverage data. Statement coverage data is data describing whether each line in program source code 304 has been executed and tested. Condition coverage data describes whether each evaluation point or condition statement has been executed and tested. Path coverage data is data describing whether every possible path through a given part of the code has been executed and tested. Entry and exit coverage data describes whether every call and return of a function been executed and tested. Code coverage data 306 is generated dynamically during runtime.

Code coverage tools analyze code as it is executed by known test cases and generates code coverage data 306 describing which code paths are executed and how many times each path is executed.

In accordance with the illustrative embodiments, static analyzer 302 includes result prioritization 308. Result prioritization 308 is a software component for using the results of static code analysis generated by static analyzer 302 and dynamic code coverage data 306 generated by a code coverage component to prioritize the results of the static code analysis.

The results of the static code analysis may be prioritized in any known or available method or technique for prioritizing or ordering results in a manner that indicates the importance of each result in the results report relative to every other result in the results report. In one embodiment, each result indicating a problem or potential problem with a line of code is tagged or labeled with a priority indicator, such as, without limitation, high priority, medium priority, or low priority. If a problem with a line of code is likely to be executed or encountered by a user on an infrequent basis during program execution, that problem has a greater chance of being missed by testing so the result describing the line of code is labeled “high priority”. If a problem described in the results report is associated with a line of code that is never executed or only executed during unusual or special circumstances, which were not covered by test runs that produced the profile data, the problem in the results report is labeled or identified as “low priority.” Likewise, a problem associated with code that is likely to be encountered by a user on a frequent basis is labeled “medium priority” because testing would have likely exposed any real problem on a frequently executed path.

The labeled results form prioritized static analysis report 310. Static analyzer 302 outputs prioritized static analysis report 310 to a user for review. The user can quickly and efficiently identify important problems in program source code by locating the entries or results in prioritized static analysis report 310 that are labeled or identified as “high priority.” The user can disregard or only briefly review entries or results in prioritized static analysis report 310 that are labeled “low priority.” In this manner, result prioritization 308 high-lights problems found by static analyzer 302 which are in code that is executed but executed infrequently and is, thus, more likely to result in a problem that may be missed by testing and would be found or encountered by a customer or other user utilizing program source code 304.

In this example, prioritized static analysis report 310 prioritizes results of static analysis using the labels “high priority”, “medium priority”, and “low priority”. However, result prioritization 308 may indicate the priority of results in prioritized static analysis report 310 by using any type of labels, identifiers, tags, ordering, or any other prioritization scheme. For example, the results may be listed in order from highest priority to the lowest priority in prioritized static analysis report 310. In this example, a label such as “high priority” would be unnecessary because the results are listed in order of priority. However, labels may also be included with the results to indicate the relative importance of each entry or result. For example, result prioritization 308 can label each result generated by static analyzer 302 with a number, letter, ranking, color, symbol, or other marking to indicate which entry is the highest priority, most executed line of code, or most likely to result in a problem during code execution.

In one embodiment, result prioritization 308 marks each entry in prioritized static analysis report 310 with a label such as “highly executed”, “medium executed”, “rarely executed”, and/or “never executed”.

In another example, result prioritization 308 color codes the results generated by static analyzer 302. Highly executed entries are one color, such as red. Entries for lines of code that are never executed or are executed only rarely are printed or displayed in a different color, such as black or green.

In another example, result prioritization 308 labels the entry result for the most executed line of code as “first”. The entry for the next most executed line of code is labeled “second” and so on. The line of code that is executed the least frequently or not at all is labeled with the label “last.”

A priority for a result may be indicated using any type of label or designation. In this example, a result associated with a line of code that is executed frequently is designated as “high priority” while a result associated with a line of code that is executed infrequently is designated “low priority.” However, in another embodiment, a line of code that is executed frequently and/or is most likely to cause a problem is designated as “low priority” and a result in prioritized static analysis report 310 associated with a line of code that is executed infrequently is designated “high priority”. Thus, a priority for a result may be indicated in any manner.

As used herein, code that is executed frequently is code that is executed a number of times that is equal to or greater than a threshold, such as, but not limited to, an upper threshold value. Code that is executed infrequently is code that is executed a number of times that is equal to or less than a low frequency threshold, such as, without limitation, a low frequency threshold.

Thus, the entries or results in prioritized static analysis report 310 may be labeled or identified in accordance with a priority ranking in any known or available method for ranking entries in a report.

In this example, result prioritization 308 uses the results generated by static analyzer 302 and code coverage data 306 to generate prioritized static analysis report 310. In another embodiment, result prioritization 308 also uses the results of performance analysis tools that are generated dynamically during runtime. The results of performance analysis tools may indicate which lines of code are performing poorly, which lines of code are utilizing a majority of the processor resources, and any other dynamically gathered data regarding the performance of executable code generated from program source code 304. This runtime performance data is used by result prioritization 308 to further refine the prioritization of the results generated by static analyzer 302 to further refine and improve the accuracy of prioritized static analysis report 310.

Thus, result prioritization 308 uses static analysis results and profile information to determine the relevance of information produced by static analyzer 302. The illustrative embodiments improve the output of a static source code analyzer by providing a prioritization for the results of the static code analysis. Result prioritization 308 looks at the line of code in program source code 304 and, based on profile data, such as code coverage data 306, describing execution characteristics of that particular line of code, result prioritization 308 determines how important the associated warning message may be and designates the warning message with an appropriate priority indicator.

In this example, result prioritization 308 is a software component included within static analyzer 302. Result prioritization 308 may be included or incorporated within static analyzer 302 as a single component. In another embodiment, result prioritization 308 is added to static analyzer 302 as a plug-in.

In yet another embodiment, result prioritization 308 is a completely separate and independent software component from static analyzer 302. In other words, result prioritization 308 is not included within static analyzer 302 as is shown in FIG. 3 but, rather, result prioritization 308 is a separate software component. In this example, static analyzer 302 outputs results of static analysis to result prioritization 308. Result prioritization 308 then independently generates prioritized static analysis report 310.

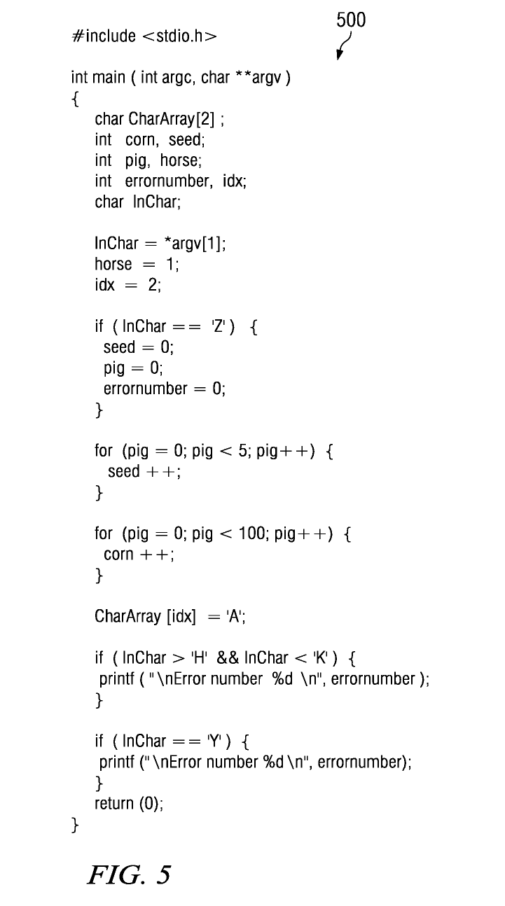

Turning now to FIG. 4, a flowchart illustrating a process for generating prioritized static analysis results is shown in accordance with an illustrative embodiment. The process in FIG. 4 is implemented by a software component for prioritizing results in a prioritized static analysis report, such as result prioritization 308 in FIG. 3.

The process begins by receiving a result or message from a results list or results report generated by a static source code analyzer, such as static analyzer 302 in FIG. 3 (step 402). The process makes a determination as to whether the result describes a problem associated with an executed line of code (step 404). If the result is not associated with an executed line of code, the process designates the result as a low priority (step 406). In other words, if the result is on an unexecuted line of code, the result associated with that line of code is designated low priority. In another embodiment, if a result is associated with a line of code that is executed less than a threshold number of times, then result is designated as low priority.

A result may be designated as low priority by labeling the result “low priority”, labeling the result “no execution”, labeling the result “not executed”, labeling the result with a number, letter, symbol, word, or other marking indicating low priority, placing the result in a particular order in a prioritized static analysis report, providing no label or indicator when all other higher priority entries are provided with a label or indicator or any other method for indicating a low priority.

The process then makes a determination as to whether all the results generated by the static source code analyzer have been prioritized (step 408). If all the results have not been prioritized, the process returns to step 402 and iteratively executes steps 404-416 until all the results are prioritized. When all the results are prioritized at step 408, the process creates a prioritized static analysis report, such as prioritized static analysis report 310 in FIG. 3, based on all the prioritized results (step 410) with the process terminating thereafter.

Returning now to step 404, if the result is associated with an executed line of code, the process makes a determination as to whether the result is associated with a highly executed line of code (step 412). If the result is associated with a highly executed line of code, the process designates the result as medium priority (step 416). A result may be designated as medium priority by labeling the result “medium priority”, labeling the result “high execution”, labeling the result with a number, letter, symbol, word, or other marking indicating medium priority, placing the result in a particular order in a prioritized static analysis report indicating medium priority, providing no label or indicator when all other higher and lower priority entries are provided with a label or indicator, or any other method for indicating a medium priority for a result.

Returning to step 412, if the result is not on a highly executed line of code, the process designates the result as high priority (step 414). A result may be designated as high priority by labeling the result “high priority”, labeling the result “medium execution”, labeling the result with a number, letter, symbol, word, or other marking indicating high priority, placing the result in a particular order in a prioritized static analysis report, placing the result at the top of a result list or result report, providing no label or indicator when all other lower priority entries are provided with a label or indicator, or any other method for indicating a high priority.

After designating the result as high priority at step 414, designating the result medium priority at step 416, or designating the result low priority at step 406, the process makes a determination as to whether all the results are prioritized (step 408). If all results are not prioritized, the process continues to iteratively execute steps 402-416 until all results are prioritized at step 408. When all the results are prioritized at step 408, the process creates a prioritized static analysis report based on all the prioritized results (step 410) with the process terminating thereafter.

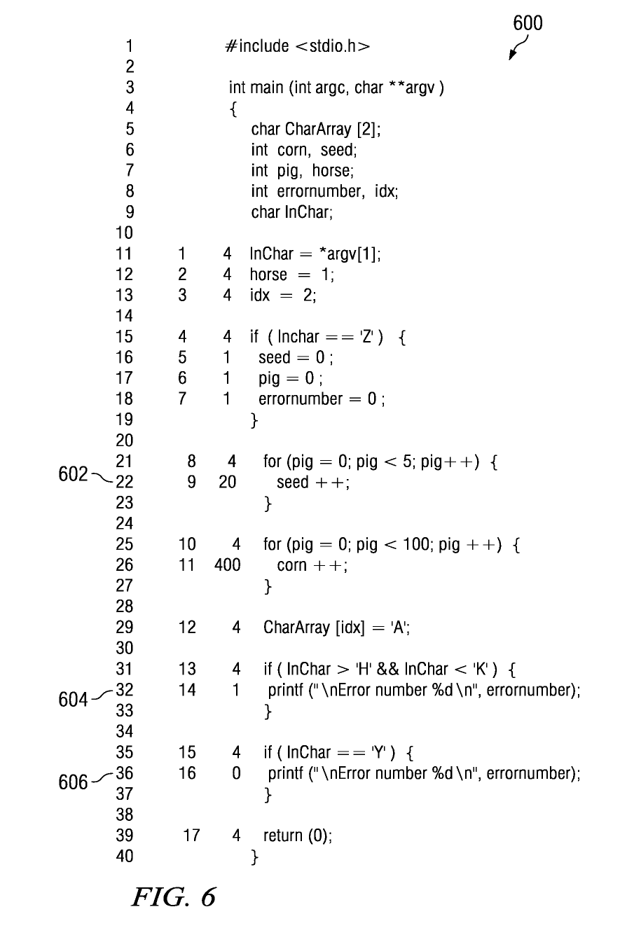

FIG. 5 is an exemplary illustration of program source code in accordance with an illustrative embodiment. Program source code 500 is an example of source code, such as program source code 304 in FIG. 3. In this example, program source code 500 is written in C programming language. However, program source code 500 may be written in any known or available programming language.

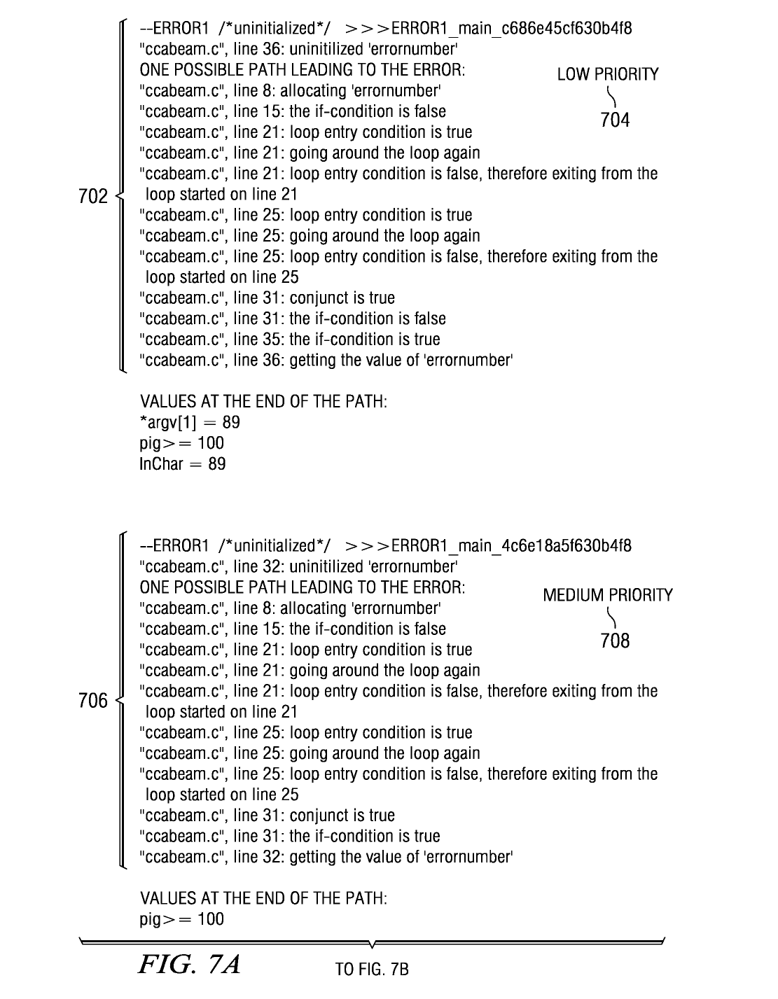

Referring now to FIG. 6, an exemplary illustration of code coverage data is depicted in accordance with an illustrative embodiment. Report 600 is an example of code coverage data generated by a code coverage component, such as code coverage data 306 in FIG. 3. Report 600 indicates data regarding execution of program source code, such as, without limitation, the number of times each line of code is executed. In this example, report 600 includes data regarding execution of program source code 500 in FIG. 5. In other words, the code coverage data in report 600 is generated dynamically by a code coverage component during runtime of executable code generated for program source code 500 in FIG. 5.

In this example, report 600 includes, but is not limited to, data indicating that line of code 22 602 is executed twenty (20) times. Line of code 32 604 is executed one (1) time. Line of code 36 606 is executed zero (0) times.

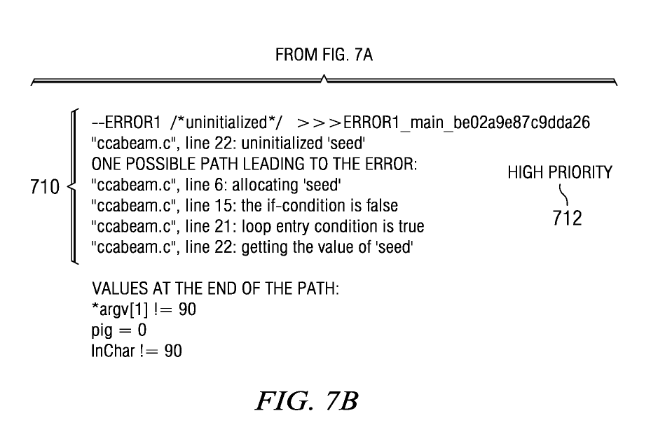

FIGS. 7A and 7B is an exemplary illustration of a prioritized static analysis report in accordance with an illustrative embodiment. Prioritized static analysis report 700 is an example of a prioritized static analysis report generated by a result prioritization component, such as prioritized static analysis report 310 in FIG. 3. In this example, prioritized static analysis report 700 is a prioritized static analysis report generated using the results of static code analysis performed for source code 500 in FIG. 5 and code coverage data 600 in FIG. 6.

In this example, information regarding a problem encountered at line of code 36 702 is designated as “low priority” 704. As shown above in FIG. 6, line of code 36 was executed zero (0) times. Therefore, the result prioritization component identifies the information regarding problems or potential problems associated with line of code 36 as low priority. In other words, a programmer is not going to be overly concerned about any problems with line of code 36 because a user or customer is not very likely to encounter any problems associated with line of code 36 due to the low likelihood line of code 36 will be executed.

Information regarding an error or potential problem encountered at line of code 22 706 is designated as “medium priority” 708. Information regarding an error or potential problem at line of code 32 710 is designated as “high priority” 712. As shown in FIG. 6, report 600 indicates that line of code 32 is executed one (1) time. Therefore, the result prioritization component identifies any problems associated with line of code 32 as a problem that is highly likely to be missed by testing procedures and encountered by a user and/or a customer. The result prioritization component designates information regarding line of code 32 710 as high priority because it is likely to be of interest or concern to the programmer, tester, or user. Thus, in this illustrative embodiment, the results of static analysis are printed, displayed, or otherwise output by the result prioritization component with a prioritization designation, label, or other indicator indicating the priority of the information associated with each result.

The illustrative embodiments provide a computer implemented method, apparatus, and computer usable program code for optimizing static code analysis reports.

It will be appreciated by one skilled in the art that the words “optimize”, “optimization” and related terms are terms of art that refer to improvements in speed and/or efficiency of a computer program, and do not purport to indicate that a computer program has achieved, or is capable of achieving, an “optimal” or perfectly speedy/perfectly efficient state.

In one embodiment, the process receives a plurality of results generated by a static code analysis for a computer program. Profile data associated with the computer program is received. A priority for each result in the plurality of results is identified to form prioritized results. A prioritized static analysis report is generated using the prioritized results. The prioritized static analysis report indicates the priority for each result in the plurality of results.

Thus, the illustrative embodiment uses code coverage data from a few representative test case runs to refine the information provided by the static source code analysis tool. The messages or results generated by the static analysis tool will be categorized and prioritized according to the execution frequency of the containing path. This ensures that the most critical problems are not overlooked. Optimizing the messages from the static analysis tool per the execution frequency of the containing paths also allows the decision of whether or not to release a formal fix to be based on the odds of the problem actually being encountered by a customer.

The embodiments may be used to make it easier for a user to identify the subset of information that is most likely to produce positive results. This increases the efficiency and cost-effectiveness of program code development and testing. In addition, a user can make better use of the information generated by the static code analyzer and increase the likelihood of obtaining positive results.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating enhanced source code analyzer results, the computer implemented method comprising:
receiving a plurality of results generated by a static code analysis for a computer program;
receiving profile data associated with the computer program;
identifying a priority for each result in the plurality of results using the profile data to form prioritized results; and
generating a prioritized static analysis report using the prioritized results, wherein the prioritized static analysis report indicates the priority for each result in the plurality of results.

2. The computer implemented method of claim 1 wherein the profile data comprises code coverage data indicating a frequency with which each line of code associated with the computer program is executed.

3. The computer implemented method of claim 1 further comprising:
designating each result in the plurality of results in association with a priority indicator indicating the priority of each result to form the prioritized results.

4. The computer implemented method of claim 3 wherein a result associated with code in the computer program that is executed a number of times that is greater than a threshold number is designated with a priority indicator indicating a high priority.

5. The computer implemented method of claim 3 wherein a result associated with code in the computer program that is never executed is designated with a priority indicator indicating a low priority.

6. The computer implemented method of claim 3 wherein a result associated with code in the computer program that is executed a number of times that is less than an upper threshold number but greater than a lower threshold number is designated with a priority indicator indicating a medium priority.

7. The computer implemented method of claim 1 further comprising:
indicating, by the priority for each result in the prioritized static analysis report, an execution frequency of code paths associated with errors.

8. The computer implemented method of claim 1 further comprising:
determining whether to develop and release a fix for a problem associated with code for the computer program using the prioritized static analysis report.

9. A computer program product comprising:
a computer usable medium including computer usable program code for generating enhanced source code analyzer results, said computer program product comprising:
computer usable program code for receiving a plurality of results generated by a static code analysis for a computer program;
computer usable program code for receiving profile data associated with the computer program;
computer usable program code for identifying a priority for each result in the plurality of results using the profile data to form prioritized results; and
computer usable program code for generating a prioritized static analysis report using the prioritized results, wherein the prioritized static analysis report indicates the priority for each result in the plurality of results.

10. The computer program product of claim 9 further comprising:
computer usable program code for designating each result in the plurality of results in association with a priority indicator indicating the priority of each result to form the prioritized results.

11. The computer program product of claim 10 wherein a result associated with code in the computer program that is code that is executed a number of times that is greater than a threshold number is designated with a priority indicator indicating a high priority.

12. The computer program product of claim 10 wherein a result associated with code in the computer program that is never executed is designated with a priority indicator indicating a low priority.

13. The computer program product of claim 10 wherein a result associated with code in the computer program that is executed a number of times that is less than an upper threshold number but greater than a lower threshold number is designated with a priority indicator indicating a medium priority.

14. The computer program product of claim 9 further comprising:
computer usable program code for indicating, by the priority for each result in the prioritized static analysis report, the execution frequency of code paths associated with errors.

15. The computer program product of claim 9 wherein the profile data comprises code coverage data indicating the frequency with which each line of code associated with the computer program is executed.

16. An apparatus comprising:
a bus system;
a communications system connected to the bus system;
a memory connected to the bus system, wherein the memory includes computer usable program code; and
a processing unit connected to the bus system, wherein the processing unit executes the computer usable program code to receive a plurality of results generated by a static code analysis for a computer program; receive profile data associated with the computer program; identify a priority for each result in the plurality of results using the profile data to form prioritized results; associating a priority indicator with each result in the prioritized results, wherein the priority indicator indicates the priority of each result; and generate a prioritized static analysis report using the prioritized results, wherein the prioritized static analysis report indicates the priority for each result in the plurality of results, and wherein the priority for each result in the prioritized static analysis report indicates a frequency of execution for code paths in the computer program associated with errors.

17. The apparatus of claim 16 wherein the processor unit further executes the computer program code to determine whether to develop and release a fix for a problem associated with code for the computer program using the prioritized static analysis report.

18. The apparatus of claim 17 wherein a result associated with code in the computer program that is executed a number of times that is greater than a threshold number is designated with a priority indicator indicating a high priority.

19. The apparatus of claim 17 wherein a result associated with code in the computer program that is never executed is designated with a priority indicator indicating a low priority.

20. The apparatus of claim 17 wherein a result associated with code in the computer program that is executed a number of times that is less than an upper threshold number but greater than a lower threshold number is designated with a priority indicator indicating a medium priority.
